(19) United States
(12) Patent Application Publication
(10) Pub. No.: US 2025/0115364 A1
(43) Pub. Date: Apr. 10, 2025

(54) POWER DISTRIBUTION SYSTEM

(71) Applicant: Rolls-Royce Deutschland Ltd & Co KG, Blankenfelde-Mahlow (DE)

(72) Inventors: Guido WORTMANN, Fürth (DE); Michael WUTTIG, München (DE); David LODER, Indianapolis, IN (US)

(21) Appl. No.: 18/481,887

(22) Filed: Oct. 5, 2023

(51) Int. Cl. B64D 35/04; B64C 29/00; B64D 35/02

(52) U.S. Cl. CPC B64D 27/35; B64C 29/0016; H02J 1/08; H02J 2310/44

(57) ABSTRACT

A power distribution system includes a plurality of energy supply systems, a plurality of first electric propulsion units, and a second electric propulsion unit different from the plurality of first electric propulsion units. Each energy supply system is configured to power at least two of the first electric propulsion units and each first electric propulsion unit is configured to be powered by at least two of the energy supply systems. Further, at least a subset of the energy supply systems is configured to power the second electric propulsion unit.

### TECHNICAL FIELD

The present disclosure relates to a power distribution system, in particular for aerospace applications.

### BACKGROUND

Electric propulsion systems for high criticality applications (e.g., aerospace) are architected to tolerate certain failure cases, including any single-point failure, while continuing safe operation. In order to achieve safe operation, power distribution systems may be implemented that include multiple energy supply systems and multiple electric propulsion units (EPUs). The multiple energy supply systems and the multiple electric propulsion units may be connected through a distribution network that implements a multilane architecture.

Electric Vertical Take Off and Landing (e-VTOL) aircraft is a high criticality application that includes different propulsors such as lift propulsors and at least one pusher propulsor that propels the aircraft during VTOL and wing-borne operation. In such applications, the power supply is able to power the different kinds of propulsors in a safe manner.

There is thus a desire to provide for a power distribution system that allows to power different kinds of propulsors in a safe manner.

### SUMMARY AND DESCRIPTION

According to an aspect of the disclosure, a power distribution system is provided. The power distribution system includes a plurality of energy supply systems, a plurality of first electric propulsion units, and a second electric propulsion unit different from the first electric propulsion units. It is provided that each energy supply system powers at least two of the first electric propulsion units, and each first electric propulsion unit is powered by at least two of the energy supply systems. It is further provided that at least a subset of the energy supply systems further powers the second electric propulsion unit.

Aspects of the disclosure are thus based on the idea to use the same energy supply systems that power the first electric propulsion units to also power the second electric propulsion unit. Such solution provides for a high safety of the power supply to the second electric propulsion unit, as a plurality of energy supply systems, namely, those that power the first energy supply systems, may be used to also supply power to the second electronic proposal unit. Accordingly, the power supply to the second electric propulsion unit is not dependent on a single energy supply system as would be the case if the second electric propulsion unit would be powered by a separate, individual energy supply system. Therefore, in case of a failure of an energy supply system, the energy of others of the energy supply systems may still be used to power the second electric propulsion unit.

At the same time, there is also provided for redundancy with respect to providing power to the first electric propulsion units, as each first electric propulsion unit is powered by at least two of the energy supply systems.

The second electric propulsion unit may be powered by all of the energy supply systems or by a subset of the energy supply systems. In an embodiment, it is provided that each energy supply system powers two of the first electric propulsion units through a corresponding power bus, wherein the second electric propulsion unit is connected to at least some of the power buses. The power buses form a connection network connecting the energy supply systems, the first electric propulsion units, and the second electric propulsion unit.

In an embodiment, the first electric propulsion units form pairs that are powered by the same two energy supply systems (wherein each of the two energy supply systems powers the two first electric propulsion units of a pair), wherein two power buses are associated with each pair of first electric propulsion units, and wherein the second electric propulsion unit is connected to half of the power buses only. Accordingly, two energy supply systems provide power to two of the first electric propulsion units, wherein half of the energy supply systems for the first electric propulsion units also power the second electric propulsion unit. This allows to evenly distribute the additional load of the second electric propulsion unit among all connected energy supply systems.

In another embodiment, the system further includes at least one switchable element, wherein each switchable element electrically connects two of the energy supply systems when switched on, wherein one of each two energy supply systems that are connectable through a switchable element is permanently connected to the second electric propulsion unit. Accordingly, an architecture is provided that allows to connect different energy supply system by a switchable element. This allows the sharing of power from the energy supply systems and/or to provide for redundancy. At the same time, the second electric propulsion unit (namely, one of its lanes/electric motors) is connected to and powered by one of the two energy supply systems. The other of the two energy supply system joins in powering the second electric propulsion unit if the switchable element is switched on and connects the two energy supply systems. Accordingly, each pair of energy supply systems is configured to jointly power the second electric propulsion unit when the respective switchable element is switched on.

To implement such architecture, a multilane architecture is provided that allows to connect different lanes by a switchable element.

In an embodiment, the system is configured such that each energy supply system is connectable to one other energy supply system only, such that there are pairs of associated energy supply systems that may be connected through a switchable element. It is thus provided that a particular energy supply system may be electrically connected to a particular associated energy supply system only, and not to any of the other energy supply systems. Such bidirectional association is associated with the advantage that two energy supply systems have to be considered only when adjusting their voltages before connecting them. In this respect, when two batteries are connected, this may result in unwanted inrush current and/or a current flowing among batteries that may cause the system protections to trip and result in failure. Therefore, the voltages may need to be balanced between the power buses before the switchable element may be switched on to connect two power buses.

The switchable element may be implemented as a cross-tie switch, as a contactor or as a Solid State Power Controller (SSPC) device.

In another embodiment, the system further includes at least one double throw switch, wherein each double throw switch is configured to connect the second electric propulsion unit with one or another of two of the energy supply systems. Accordingly, by the double throw switch, the choice may be made that the second electric propulsion unit connects alternately to one or another of two energy supply systems. This allows to utilize the available energy of each energy supply system in a most efficient manner.

To implement such architecture, a multilane architecture is provided, wherein a power bus connected to the second electric propulsion unit is connected through the double throw switch to one or another of two power buses that are each connected to an energy supply system. By connecting the second electric propulsion unit power bus to one or another of two power buses each connected to an energy supply system, the power buses do not need to be interconnected (as with the previous embodiment using a switchable element), thereby avoiding problems associated with inrush current.

In such embodiment, each energy supply system powers two of the first electric propulsion units through a corresponding power bus, wherein the power buses are not interconnected, and each double throw switch may connect to one or the other of two of the power buses. In such system, the number of double throw switches is half the number of the energy supply systems and power buses.

In an embodiment, each double throw switch is connected to the second electric propulsion unit through a protection device that is located in a power bus that connects the second electric propulsion and the double throw switch. Such protection device may be a current breaker. The provision of additional protection devices provides for additional protection of the second electric propulsion unit. Such protection devices may be implemented in other embodiments as well.

In a further embodiment, each double throw switch is associated with a pre-charge circuit configured to limit inrush current occurring when the double throw switch switches from one energy supply system/power bus to the other energy supply system/power bus. For example, the pre-charge circuit includes the double throw switch and two additional double throw switches each of which is arranged in one of the power buses, wherein each additional double throw switch is configured to connect to one or the other of first and second local branches of the respective power bus, each first local branch including a resistor, wherein the local branches combine before the respective energy supply system. The use of such pre-charge circuit allows a transition from the double throw switch connecting to one of the power buses to the double throw switch connecting to the other of the power buses in a manner that avoids inrush current during the transition. In particular, the resistor in one of the local branches limits any inrush current when the double throw switch connects to another of the power buses.

In an embodiment, the pre-charge circuit includes a controller configured to control the double throw switch and the two additional double throw switches of each pre-charge circuit such that when the double throw switch switches from one energy supply system to the other energy supply system: the additional double throw switch in the power bus of the other energy supply system connects to the first local branch that includes the resistor; the double throw switch switches to the other energy supply system; and the additional double throw switch in the power bus of the other energy supply system connects to the second local branch.

In this manner, when the double throw switch connects to the other power bus, inrush current is limited by choosing the local branch that includes the resistor. Subsequently, after the inrush current has ceased or decreased below a lower limit, the other local branch is chosen by the respective additional double throw switch to enable full power from the other energy supply system.

In still another embodiment, the number of first electric propulsion units is larger than the number of energy supply systems, wherein a connection network connecting the energy supply systems, the first electric propulsion units and the second electric propulsion unit includes a diode network that provides power of at least some of the energy supply systems to the second electric propulsion unit. The diode network may further provide for additional power to those first electric propulsion units not directly powered by two energy supply systems (such first electric propulsion units are necessarily present as the number of energy supply systems is smaller than the number of first electric propulsion units).

Such an aspect is based on the idea to address the problem of mapping the energy of a first number of energy supply systems to a second, larger number of first electric propulsion units and the second electric propulsion unit by implementing a diode network, wherein the second electric propulsion unit connects to at least some of the energy supply systems through the diode network.

To implement such aspect, in an embodiment, each energy supply system powers two of the first electric propulsion units through a corresponding power bus, and the second electric propulsion unit is connected through the diode network to at least some of the power buses (and may be connected to all of the power buses). For example, there are provided six energy supply systems, each energy supply system providing through a corresponding power bus energy to two first electric propulsion units. To also provide power to the second electric propulsion unit, the diode network contacts to each of the six power buses.

As mentioned, the diode network may further provide for additional power to those first electric propulsion units that are not powered by two energy supply systems. Accordingly, in an embodiment, some of the first electric propulsion units are directly powered by some of the energy supply systems and some of the first electric propulsion units are at least partially powered through the diode network.

In a further embodiment, the number of first electric propulsion units is even and the first electric propulsion units are arranged in a symmetrical manner in an aircraft, wherein the system is configured to, if one of the first electric propulsion units fails, to switch off another of the first electric propulsion units to maintain the symmetry of the first electric propulsion units and the thrust and/or lift provided by them. By maintaining symmetry of the first electric propulsion units even in case of a failure, the thrust/lift provided by the first electric propulsion units remains balanced.

Such embodiment may be implemented in particular with electric Vertical Take Off and Landing aircrafts (e-VTOLs). E-VTOLs include a plurality of lift propulsors. If one of the lift propulsors fails, another lift propulsors is switched off to maintain a balanced thrust.

In certain embodiments, the total load of the electric propulsion units (EPU load) may be evenly distributed or to a high degree evenly distributed to all energy supply systems. This may apply during normal operation and failure cases. For example, when one aircraft rotor (or the EPU) fails, all energy supply systems see the same load and, hence, may be sized as small as possible. At least for batteries, the power is the design driver for VTOL applications. Also during the loss of one energy supply system, the remaining supply systems see the same load by applying an appropriate thrust/lift distribution with all EPUs. At the same time, the entire propulsion system may still be kept in separate lanes. There is no interconnection between all energy supply systems required, which provides the fault tolerance of the electronic propulsion system.

In embodiments, the energy supply system may be provided by an electric battery. Such electric battery may be coupled with a battery management system. Such electric battery may further be equipped with a DC/DC converter that provides a constant DC output voltage. In another embodiment, the energy supply system may be a fuel-cell or a fuel cell system, such as a hydrogen fuel cell system. Such fuel cell system may also be equipped with a DC/DC converter. In still other embodiments, the energy supply system may be a turbo generator with a rectifier. The energy supply system may be a DC energy supply system.

In an embodiment, the first electric propulsion units are rotors that propel an aircraft in a first direction, and the second electric propulsion units are rotors that propel an aircraft in a second direction. For example, the first electric propulsion units are lift rotors of an e-VTOL and the second electric propulsion unit is a pusher rotor of the e-VTOL. In such embodiment, the energy supply systems that power the lift rotators also power the pusher rotor.

In an embodiment, the system includes an even number of first electric propulsion units (e.g., eight first electric propulsion units) and a single second electric propulsion unit. However, in other embodiment, there may be provided several second electric propulsion units.

In a further embodiment, each first electric propulsion unit includes a plurality of electric motors, wherein each energy supply system that powers a first electric propulsion unit powers one of the electric motors of that electric propulsion unit. At the same time, the second electric propulsion unit also includes a plurality of electric motors, wherein each of the energy supply systems that powers the second electric propulsion unit powers one of the electric motors of the second electric propulsion unit. Accordingly, redundancy or partial redundancy of the electric propulsion units may be provided for by integrating a plurality, in particular two electric motors in each electric propulsion unit. In this respect, it is pointed out that “electric motor” may refer to two physically different machines connected to the same shaft, or two sets of windings wound in the same machine, each fed by a different energy supply system.

Further, an energy supply system may power an electric propulsion unit through a respective power converter, as is known to the skilled person.

In a still further aspect of the disclosure, a power distribution system is provided. The power distribution system includes a plurality of energy supply systems, a plurality of first electric propulsion units, and a second electric propulsion unit different from the first electric propulsion units, wherein each energy supply system powers at least two of the first electric propulsion units, and each first electric propulsion unit is powered by at least two of the energy supply systems. Additionally, the power distribution system includes at least one double throw switch, wherein each double throw switch is configured to connect the second electric propulsion unit with one or another of two of the energy supply systems.

Such an aspect is based on the idea that the electric propulsion unit may connect alternately to one or another of two energy supply systems. This is provided for by the at least one double throw switch. Accordingly, by the double throw switch, a choice may be made that the second electric propulsion unit connects alternately to one or another of two energy supply systems. This allows to utilize the available energy of each energy supply system in a most efficient manner.

To implement such architecture, a multilane architecture is provided, wherein a power bus connected to the second electric propulsion unit is connected through the double throw switch to one or another of two power buses that are each connected to an energy supply system. By connecting the second electric propulsion unit power bus to one or another of two power buses each connected to an energy supply system, the power buses do not need to be interconnected, thereby avoiding problems associated with inrush current when interconnecting two power buses and the respective energy supply systems.

In such embodiment, each energy supply system powers two of the first electric propulsion units through a corresponding power bus, wherein the power buses are not interconnected, and each double throw switch may connect to one or the other of two of the power buses. In such system, the number of double throw switches is half the number of the energy supply systems and power buses.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

The disclosure is explained in more detail on the basis of exemplary embodiments with reference to the accompanying drawings in which:

FIG. 1 depicts an embodiment of a multilane power distribution system including multiple energy supply systems, multiple first electric propulsion units, a second electric propulsion unit, and a connection network that includes power buses for connecting the energy supply systems and the electric propulsion units, wherein the second electric propulsion unit is powered by a subset of the energy supply systems.

FIG. 2 depicts a further embodiment of a multilane power distribution system including multiple energy supply systems, multiple first electric propulsion units, a second electric propulsion unit, and a connection network that includes power buses for connecting the energy supply systems and the electric propulsion units, wherein two associated power buses and batteries may be electrically connected through contactors.

FIG. 3 depicts a further embodiment of a multilane power distribution system including multiple energy supply systems, multiple first electric propulsion units, a second electric propulsion unit, and a connection network that includes power buses for connecting the energy supply systems and the electric propulsion units, wherein double throw switches are provided that are configured to connect the second electric propulsion unit with one or another of two of the energy supply systems.

FIG. 4 depicts an embodiment of a pre-charge circuit that may be implemented with the power distribution system of FIG. 3.

FIG. 5 depicts a further embodiment of a multilane power distribution system including multiple energy supply systems, multiple first electric propulsion units, a second electric propulsion unit, and a connection network that includes power buses for connecting the energy supply systems and the electric propulsion units, wherein the number of energy supply systems is lower than the number of first electric propulsion units, and wherein the connection network includes a diode network configured to provide power of at least some of the energy supply systems to the second electric propulsion unit to achieve an even power share among all energy supply systems.

### DETAILED DESCRIPTION

With increased penetration of electrical systems and the progression towards full electric and hybrid propulsion systems, the use of DC multilane power distribution systems has gained increased use.

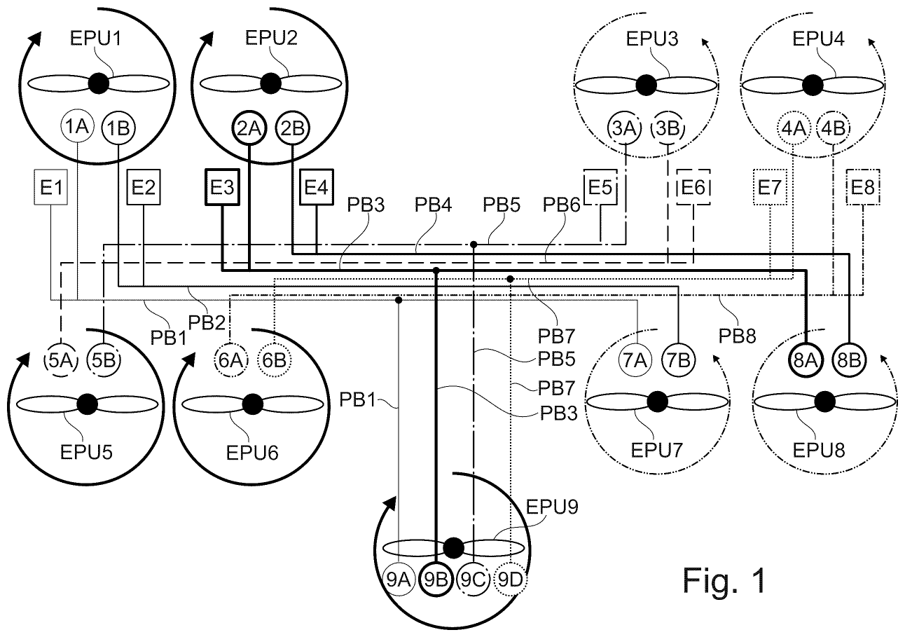

FIG. 1 shows a first embodiment of a DC multilane power distribution system, wherein the system includes a plurality of energy supply systems E1 to E8, a plurality of first electric propulsion systems EPU1 to EPU8, and a second electric propulsion unit EPU9. The propulsion units EPU1 to EPU9 are connected through a DC distribution system. The electronic propulsion units are, in the following, referred to as EPUs.

The energy supply systems E1 to E8 may be or include batteries or fuel cell systems. They may be associated with a battery management system and a DC/DC converter that provides for a constant DC output voltage. The energy supply systems E1 to E8 are, in the following, mainly referred to as batteries for simplicity, without limiting the energy supply systems to batteries.

Each of the first EPUs, EPU1 to EPU8, includes two electric motors. For example, EPU1 includes electric motor 1A, which is driven by battery E1 through a power converter/inverter (not shown). EPU1 further includes electric motor 1B, which is driven by battery E2 through another power converter/inverter (not shown). For example, the power converters each provide for a three phase alternating current that drives the respective electric motors 1A, 1B. In this respect, it is pointed out that the electric motors such as electric motors 1A, 1B may be two physically different machines connected to the same shaft, or maybe two sets of windings wound in the same machine, each fed by a different power converter. The two electric motors/motor windings of each first EPU represent isolated “lanes” of that EPU that are powered by different of the batteries.

In a similar manner, each of the other first EPUs, EPU2 to EPU8, include two electric motors 2A, 2B, 3A, 3B, 4A, 4B, 5A, 5B, 6A, 6B, 7A, 7B, 8A, 8B, and corresponding power converters as well.

The second EPU9 includes four electric motors 9A, 9B, 9C, 9D. The second EPU may be different from the first EPUs in that the second EPU propels an aircraft in a different direction than the first EPUs. Additionally, or alternatively, the second EPU may be different from the first EPUs in that the second EPU's electric motors 9A, 9B, 9C, 9D have different power requirements than the electric motors of the first EPUs.

In the depicted embodiment, the first EPUs, EPU1 to EPU8, include propellers, wherein half of the propellers turn in one direction and the half of the propellers turn in the other direction, such as is used in e-VTOLs. The first EPUs, EPU1 to EPU8, may represent lift rotors of an e-VTOL that create lift during VTOL operation, and the second EPU9 may represent a pusher rotor of an e-VTOL that creates thrust and pushes the aircraft forward.

The DC distribution network includes eight power buses PB1 to PB8, wherein each power bus PB1 to PB8 is connected to one of the batteries E1 to E8 and each power bus PB1 to PB8 powers portions (namely, one of the electric motors) of two of the first EPUs EPU1 to EPU8. It is pointed out that each power bus includes a high side voltage rail connected to a positive battery voltage and a low side voltage rail connected to a negative battery voltage, as is known to the skilled person.

The architecture of the multilane power distribution system of FIG. 1 implements redundancy and power sharing aspects as follows:

First, each battery E1-E8 powers two first EPUs. For example, battery E1 powers EPU1 and EPU7. In another example, battery E3 powers EPU2 and EPU8.

Second, each of the first EPUs, EPU1 to EPU8, is powered by two of the batteries E1-E8. For example, EPU1 is powered by battery E1 and by battery E2. EPU2 is powered by battery E3 and battery E4. EPU3 is powered by battery E5 and by battery E6, etc.

Third, two of the batteries are assigned to each other in the sense that the first EPUs form pairs that are powered by the same two energy supply systems. More particularly, the power distribution system of FIG. 1 forms four pairs, the pairs being formed by EPU1 and EPU7, by EPU2 and EPU8, by EPU3 and EPU5, and by EPU4 and EPU6. The EPUs of a pair are powered by the same two energy supply systems. For example, the first pair (EPU1 and EPU7) is powered by batteries E1 and E2. The second pair (EPU2 and EPU8) is powered by batteries E3 and E4, etc.

Two of the power buses are associated with each of the pairs. For example, power buses PB1, PB2 are associated with the pair formed by EPU1 and EPU7. Power buses PB3, PB4 are associated with the power formed by EPU2 and EPU8, etc.

It is further provided that the second EPU 9 is connected to half of the power buses, namely, power buses PB1, PB3, PB5, and PB7. More particularly, each of the power buses PB1, PB3, PB5, and PB7 is connected to one of the four electric motors 9A, 9B, 9C, 9D of EPU9 (through a power converter/inverter not shown). Therefore, in the embodiment of FIG. 1, the first batteries E1, E3, E5, E7 each power two of the first EPUs, EPU1-EPU8, and the second EPU9, wherein batteries E2, E4, E6, E8 only each power two of the first EPUs, EPU1-EPU8. However, because of the forming of pairs of the first EPUs that are powered by the same two batteries, there is provided for an evenly distribution of the power of the batteries E1 to E8 to first the electric propulsion units EPU1 to EPU8 even though a subset only of the batteries provides power to the second electric propulsion unit EPU9

The information that the first batteries E1, E3, E5, E7 each power two of the first EPUs, EPU1-EPU8, and the second EPU9 may imply that for each battery two first EPUs and the second EPU (more precisely, the respective electric motors) are connected in parallel to a power bus that is powered by the battery.

In the embodiment of FIG. 1, a power distribution system is provided for in which a subset E1, E3, E5, E7 of the energy supply systems E1-E8 further powers the second electric propulsion unit EPU9, wherein the second electric propulsion unit EPU9 is connected to half of the power buses PB1, PB3, PB5, PB7.

More particularly, EPU9 requires four lanes or power buses in order to provide the required power and provide sufficient safety margin. At the same time, eight independent batteries E1-E8 with eight independent power buses PB1-PB8 are required. While the system of FIG. 1 is effective in that the same energy supply systems that power the first electric propulsion units also power the second electric propulsion unit, it is not possible to use all of the batteries E1 to E8 to power the second electric propulsion unit EPU9 and thus provide the full energy that is available to the EPU9.

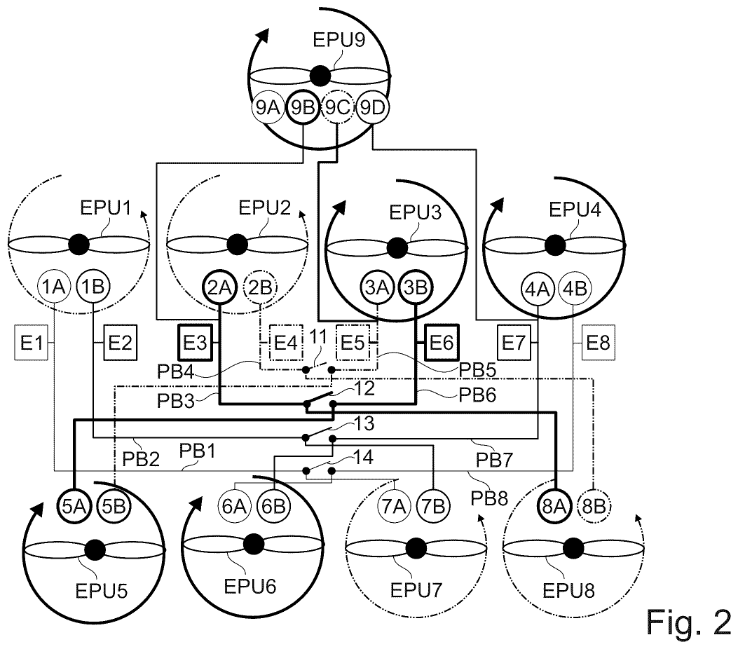

FIG. 2 shows an embodiment of a power distribution system that shows more flexibility in that the power of all batteries E1 to E8 may be provided to the second electric propulsion unit EPU9.

The power distribution system of FIG. 2 may be similar to the power distribution system of FIG. 1 unless differences are pointed out in the following.

In the power distribution system of FIG. 2, it is provided that two of the batteries are assigned to each other in the sense that a particular of the batteries may be electrically connected to another one of the batteries, wherein each battery may be connected to one associated other battery only, such that there exist pairs of associated energy supply systems. For example, batteries E4, E5 are assigned to each other. They may be connected through a switchable element 11 that connects the respective power buses PB4, PB5 when switched on. The switchable element may be a cross-tie switch, a contactor, or an SSPC device. The switchable element in the following is referred to as switch.

In a similar manner, batteries E3, E6 are assigned to each other. They may be connected through a switch 12 that connects the respective power busses PB3, PB6. Further, batteries E2, E7 are assigned to each other. They may be connected through a switch 13 that connects the respective power buses PB2, PB7. Also, batteries E1, E8 are assigned to each other. They may be connected through a switch 14 that connects the respective power buses PB1, PB8.

It is pointed out that each power bus includes a high side voltage rail connected to a positive battery pole and a low side voltage rail connected to a negative battery pole. It is further pointed out that the switches 11-14 each include a switch for the high side voltage rail and a switch for the low side voltage rail (not shown in detail). When two batteries are connected, the high side voltage rails are connected, and the low side voltage rails are connected.

In the embodiment of FIG. 2, it is further provided that one of each pair of energy supply systems E4, E5; E3, E6; E2, E7; E1, E8 is permanently connected to the second electric propulsion unit EPU9. For example, battery E5 is permanently connected through power bus PB5 to electric motor 9C of EPU9.

If switch 11 is opened (switched off), the two power buses PB4, PB5 are separated and electric motor 9C receives power through battery E5 only. On the other hand, if switch 11 is closed (switched on), the two power buses PB4 and PB5 and the respective batteries E4 and E5 are connected such that battery E4 joins to power electric motor 9C of EPU9. Electric motor 9C is then jointly powered by batteries E4 and E4. The situation is similar with respect to electric motors 9A, 9B and 9C of EPU9.

Accordingly, the embodiment of FIG. 2 allows to potentially use all of the batteries E1 to E8 to power the second electric propulsion unit EPU9, wherein it depends on the switching status of the switches 11 to 14 if batteries E2, E4, E6 and E8 join in powering the second EPU9.

However, it is to be noted that sharing energy stored in batteries is not straightforward. Different batteries may be discharged differently and may, therefore, have different voltages at the time they are connected. When batteries are connected that have different voltages, this results in unwanted inrush current and/or current flowing among the batteries. Further, there may be load capacities present or associated with the loads of the batteries, wherein such load capacities may also cause an inrush current.

More particularly, in the configuration of FIG. 2, each switch 11-14 may be normally open (NO) or normally closed (NC). In the NO configuration, the switch may be closed only during certain flight phases where the full energy is required. In certain cases, the closed state may correspond with a less critical phase of flight. However, if the batteries E1 to E8 have a variable voltage output (e.g., if the batteries are not equipped with a DC/DC converter), voltage is balanced between the power buses PB1 to PB8 before the switch may be closed. In the NC configuration, the switches 11-14 are closed during startup and remain closed during the full mission. If not fully balanced, the system protections may trip due to the inrush current. In this case, the switches 11-14 are able to break fault current in order to separate the power buses in a failure event.

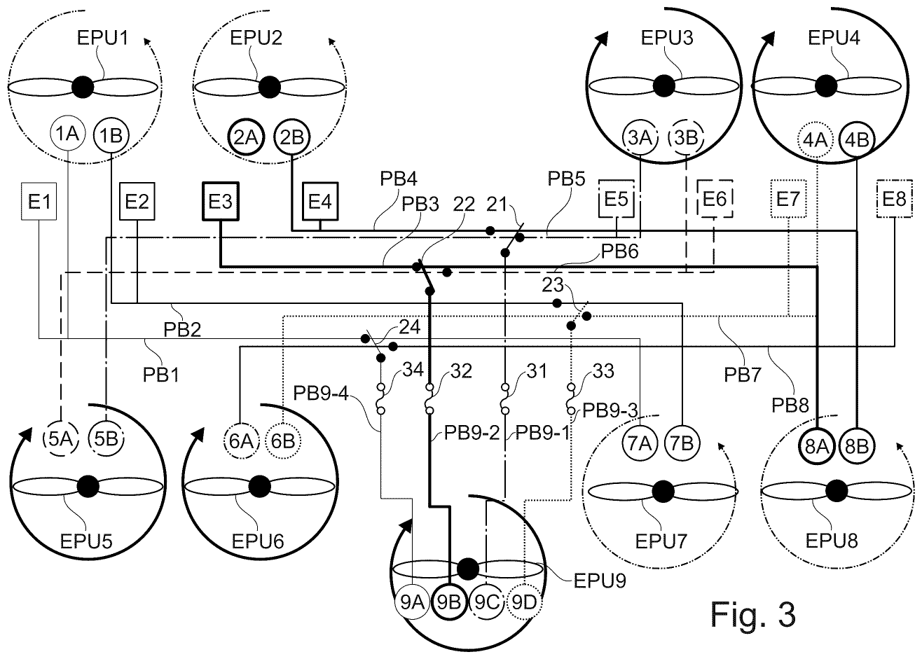

FIG. 3 shows an embodiment of a power distribution system that shows flexibility in that the power of all batteries E1 to E8 may be provided to the second electric propulsion unit EPU9, wherein the system is further simplified in that there is no need to balance voltages between the power buses before a switch may be closed.

The power distribution system of FIG. 3 may be similar to the power distribution system of FIG. 1 unless differences are pointed out in the following.

In the embodiment of FIG. 3, double throw switches 21-24 are implemented, wherein each double throw switch is configured to connect the second electric propulsion unit with one or another of two of the energy supply systems. More particularly, each double throw switch 21-24 may connect to one or the other of two of the power buses PB1 to PB8.

A double throw switch may include three terminals and connect a source terminal and one of two output terminals. In FIG. 3, the source terminal of each switch 21 to 24 is connected through a pusher power line PB9-1, PB9-2, PB9-3, PB9-4 to the second EPU9, namely, one of the electric motors 9A to 9D of EPU9. In each of these pusher power lines PB9-1 to PB9-4, a protection device 31-34 is located for circuit protection.

The two output terminals of each double throw switch 21-14 each connect to one of the pusher power buses PB1 to PB8. Accordingly, by switching the double throw switch 21-24, the second EPU9 (namely, the respective electric motor 9A to 9D) may be connected to one or another of the two power buses to which the respective double throw switch may connect. For example, double throw switch 21 may connect to power bus PB4 or power bus PB5. If connected to power bus PB4, the second EPU is powered by battery E4. If connected to power bus PB5, the second EPU is powered by battery E5.

Each double throw switch 21 to 24 is thus used to alternate lane inputs between two batteries in order to utilize the available energy of each battery. This way, the two power buses that provide input to a pusher power bus PB9-1 to PB9-4 are never interconnected, thereby avoiding potential pitfalls resulting from inrush currents that occur when connecting two batteries. During the connection change-over, any voltage stemming from capacitive loads such a DC link capacitors will be forced to the voltage of the battery to which it is being connected. However, as such capacitive loads have a small amount of energy in comparison to a battery, the inrush current will persist only for a short duration that will not trip the system protections.

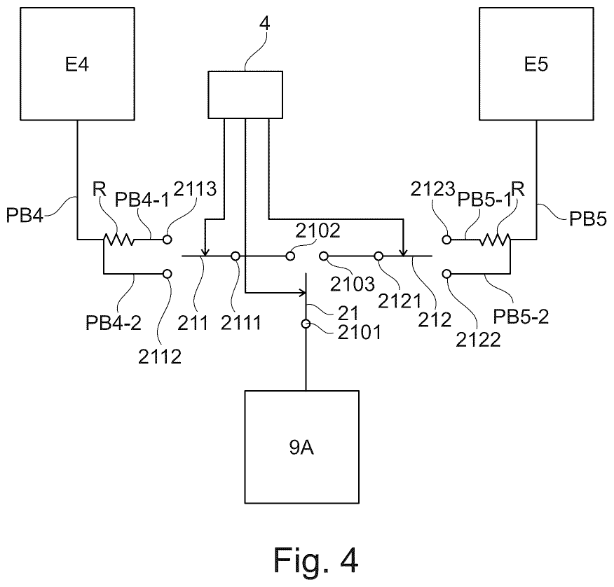

In case that the inrush current is not manageable, a pre-charge circuit may be implemented in accordance with FIG. 4 for each double throw switch 21 to 24.

FIG. 4 depicts a pre-charge circuit that includes the double throw switch 21 of FIG. 3 and two additional double throw switches 211, 212, each of which is arranged in one of the power buses PB4, PB5. Double throw switch 21 includes a source terminal 2101 and two output terminals 2102, 2103. Double throw switch 211 includes a source terminal 2111 and two output terminals 2112, 2113. Double throw switch 212 includes a source terminal 2121 and two output terminals 2122, 2123. The output terminals 2102 and 2103 of double throw switch 21 are connected to the input terminals 2111 and 2121 of double throw switches 211 and 212.

Each additional double throw switch 211, 212 is configured to connect to one or the other of first and second local branches PB4-1, PB4-2, PB5-1, PB5-2 of the power buses PB4, PB5. The first and second local branches connect at their one end to the output terminal of the respective double throw switch 211, 212 and combine at the other end before the respective battery E4, E5. In each of the first local branches PB4-1 and PB5-1 a resistor R is located.

There is further provided a controller 4 that provides control signals to the double throw switches 21, 211, 212 of the pre-charge circuit to determine the switching status. The controller may be part of the pre-charge circuit or be a more general controller providing control signals to a plurality of devices.

In the following, the situation is discussed as an example in which the double throw switch 21 changes from a connection with power bus PB4 and battery E4 to a connection with power bus PB5 and battery E5. The controller 4 is configured to control the double throw switch 21 and the two additional double throw switches 211, 212 of each pre-charge circuit such that when the double throw switch 21 switches from battery E4 to the other battery E5 (thereby contacting the source terminal 2121 of double throw switch 212), initially the additional double throw switch 212 connects to the first local branch PB5-1 that includes the resistor R. Subsequently, the double throw switch 21 switches from power bus PB4 to power bus PB5. Because of the chosen position of double throw switch 212, any inrush current runs through local branch PB5-1 and resistor R, wherein the resistor R limits the inrush current. After the voltage stabilizes, the additional double throw switch 212 in power bus PB5 connects to the second local branch PB5-2 to enable full power from battery E5. Double throw switch 211 may then transition to the top position (output terminal 2113 and local branch PB4-1) in preparation for the transition back to power from E4.

The embodiment of FIGS. 3 and 4 allows to fully utilize the energy in the batteries E1 to E8 in that the double throw switch 21 to 24 are alternated over the course of a mission as needed. The switching of the double throw switches 21 to 24 may be controlled by a controller such as controller 4 of FIG. 4. The controller may include a microprocessor, a memory, and associated software. Such controller may continuously receive input about the power levels of the batteries and the power consumption of the first and second EPUs and make switching decisions based on these parameters.

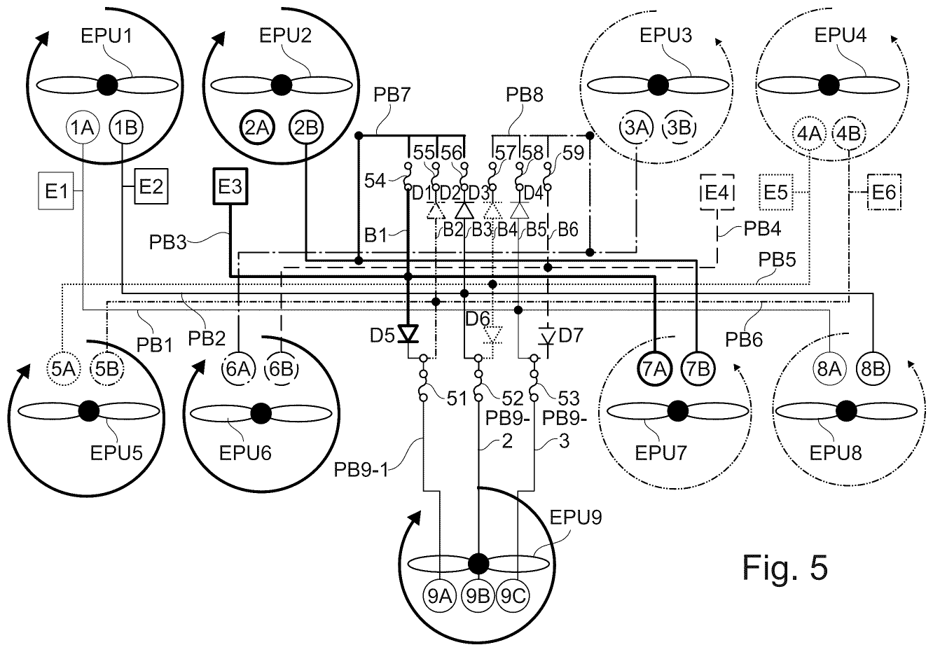

FIG. 5 shows a further embodiment of a power distribution system. The power distribution system of FIG. 3 may be similar to the power distribution system of FIG. 1 unless differences are pointed out in the following.

The power distribution system of FIG. 5 differs from the power distribution system of FIG. 1 first in that the number of energy supply systems/batteries E1 to E6 is not equal with, but smaller than the number of first electric propulsion units EPU1 to EPU8. In particular, while there are provided eight EPUs, there are provided six batteries only. Second, the power distribution system of FIG. 5 differs from the power distribution system of FIG. 1 in that the connection network that connects the batteries E1 to E6, the first EPUs EPU1 to EPU8, and the second EPU EPU9 includes a diode network that makes up for the lack of batteries and provides for an even or largely even supply of power from the batteries all to EPUs including the second EPU9.

Because of the limited number of batteries, there are provided six power buses PB1 to PB6 directly connected to a battery only as well. As described with respect to the embodiment of FIG. 1, it is still provided that each battery powers two of the first EPUs through a corresponding power bus. For example, battery E1 powers electric motor 1A of EPU1 and electric motor 8A of EPU8. However, EPU2, EPU3, EPU6 and EPU7 are directly powered by one battery only, wherein the respective battery powers only one of the two electric motors. For example, electric motor 2A of EPU2 is directly powered by battery E3, wherein electric motor 2B is not directly powered by any battery.

However, through the diode network, additional power is provided to the respective redundant electric motors 2B, 7B, 3A, 6A. Further, the second EPU9 includes three electric motors 9A, 9B, 9C, each of which is also powered through the diode network. By the diode network, accordingly, power is provided to the electric motors of the second EPU9 and to those electric motors of the first EPUs that are not directly powered by a battery.

The electric motors 9A, 9B, 9C of second EPU9 are connected through a respective pusher power line PB9-1, PB9-2, PB9-3 to the diode network. In each of these pusher power lines PB9-1 to PB9-3, a protection device 31-34 is located for circuit protection.

The diode network includes diodes D1 to D7 located in branches B1-B6, wherein each branch B1 to B6 is connected to one of the power buses PB1 to PB6. The upper ends of branches B1 to B3, through respective further protection device 54-56, join and contact power bus PB7 (which is not connected to a battery). Similarly, the upper ends of branches B4 to B6, through respective further protection device 57-59, join and contact power bus PB8 (which is also not connected to a battery). This way, power is provided to power buses PB7 and PB8 and the respective electric motors 2B, 7B, 3A, 6A connected to these power buses. Accordingly, each battery E1 to E6 supplies power to four of the electric motors, namely, to two electric motors directly through the respective power bus and to two electric motors through the diode network.

The protection devices 51-59 are implemented to prevent failure propagation through the diodes, avoiding the loss of multiple buses due to lane failure. The protection devices enable a fault tolerant system.

Further, the lower ends of branches B1, B2 are connected to pusher power line PB9-1, the lower ends of branches B3, B4 are connected to pusher power line PB9-2, and the lower ends of branches B5, B6 are connected to pusher power line PB9-3. This way, power is provided to the electric motors 9A, 9B, 9C of the second electric propulsion unit EPU9.

In the system of FIG. 5, the second electric propulsion unit EPU9 is connected through the diode network to all of the power buses PB1 to PB6 that are connected to a battery E1 to E6. Alternatively, the second EPU9 may be connected to only some of these power buses.

FIG. 5 illustrates how diodes may be used to achieve a symmetric distribution of power between six batteries E1 to E6, allowing an even loading of the EPUs.

It should be understood that the above description is intended for illustrative purposes only and is not intended to limit the scope of the present disclosure in any way. Also, those skilled in the art will appreciate that other aspects of the disclosure may be obtained from a study of the drawings, the disclosure, and the appended claims. All methods described herein may be performed in any suitable order unless otherwise indicated herein or otherwise clearly contradicted by context. Various features of the various embodiments disclosed herein may be combined in different combinations to create new embodiments within the scope of the present disclosure. In particular, the disclosure extends to and includes all combinations and sub-combinations of one or more features described herein. Any ranges given herein include any and all specific values within the range and any and all sub-ranges within the given range.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

1. A power distribution system comprising:
a plurality of energy supply systems;
a plurality of first electric propulsion units; and
a second electric propulsion unit different from the plurality of first electric propulsion units,
wherein each energy supply system of the plurality of energy supply systems is configured to power at least two electric propulsion units of the plurality of first electric propulsion units,
wherein each first electric propulsion unit of the plurality of first electric propulsion units is configured to be powered by at least two energy supply systems of the plurality of energy supply systems, and
wherein at least a subset of the energy supply systems of the plurality of energy supply systems is configured to power the second electric propulsion unit.

2. The power distribution system of claim 1, wherein each energy supply system of the plurality of energy supply systems is configured to power two first electric propulsion units of the plurality of first electric propulsion units through a corresponding power bus of a plurality of power buses, and
wherein the second electric propulsion unit is connected to at least some power buses of the plurality of power buses.

3. The power distribution system of claim 2, wherein the plurality of first electric propulsion units comprise pairs of electric propulsion units configured to be powered by a same two energy supply systems,
wherein two power buses of the plurality of power buses are associated with each pair of electric propulsion units of the plurality of first electric propulsion units, and
wherein the second electric propulsion unit is only connected to half of the plurality of power buses.

4. The power distribution system of claim 1, further comprising:
at least one switchable element,
wherein each switchable element of the at least one switchable element is configured to electrically connect two energy supply systems of the plurality of energy supply systems when switched on, and
wherein one energy supply system of each two energy supply systems configured to be connected through a switchable element is permanently connected to the second electric propulsion unit.

5. The power distribution system of claim 4, wherein each energy supply system of the plurality of energy supply systems is connected to only one other energy supply system such that there are pairs of associated energy supply systems.

6. The power distribution system of claim 5, wherein energy supply systems of each pair of associated energy supply systems are configured to jointly power the second electric propulsion unit when the respective switchable element is switched on.

7. The power distribution system of claim 1, further comprising:
at least one double throw switch,
wherein each double throw switch of the at least one double throw switch is configured to connect the second electric propulsion unit with a first energy supply system or a second energy supply system of two energy supply systems of the plurality of energy supply systems.

8. The power distribution system of claim 7, wherein each energy supply system of the plurality of energy supply systems is configured to power two first electric propulsion units of the plurality of first electric propulsion units through a corresponding power bus of a plurality of power buses,
wherein the plurality of power buses is not interconnected, and
wherein each double throw switch is configured to connect to a first power bus or a second power bus of two power buses of the plurality of power buses.

9. The power distribution system of claim 8, wherein a number of double throw switches is half a number of the plurality of energy supply systems and the plurality of power buses.

10. The power distribution system of claim 8, wherein each double throw switch of the at least one double throw switch is associated with a pre-charge circuit configured to limit inrush current occurring when the respective double throw switch switches from the first power bus to the second power bus of the two power buses.

11. The power distribution system of claim 10, wherein each pre-charge circuit comprises the double throw switch and two additional double throw switches arranged in a power bus of the plurality of power buses,
wherein each additional double throw switch is configured to connect to a first local branch or a second local branch of the respective power bus,
wherein each first local branch comprises a resistor, and
wherein the first local branch and the second local branch combine before the respective energy supply system of the plurality of energy supply systems.

12. The power distribution system of claim 11, wherein each pre-charge circuit comprises a controller configured to control the double throw switch and the two additional double throw switches of the respective pre-charge circuit such that when the double throw switch switches from the first energy supply system to the second energy supply system:
the additional double throw switch in the power bus of the second energy supply system connects to the first local branch that comprises the resistor;
the double throw switch switches to the second energy supply system; and
the additional double throw switch in the power bus of the second energy supply system connects to the second local branch.

13. The power distribution system of claim 1, wherein a number of first electric propulsion units is larger than a number of energy supply systems,
wherein a connection network connecting the plurality of energy supply systems, the plurality of first electric propulsion units, and the second electric propulsion unit comprises a diode network,
wherein the diode network is configured to provide power of at least some of the plurality of energy supply systems to the second electric propulsion unit.

14. The power distribution system of claim 13, wherein each energy supply system of the plurality of energy supply systems is configured to power two electric propulsion units of the plurality of first electric propulsion units through a corresponding power bus of a plurality of power buses, and
wherein the second electric propulsion unit is connected through the diode network to at least some power buses of the plurality of power buses.

15. The power distribution system of claim 1, wherein a number of first electric propulsion units is even,
wherein the plurality of first electric propulsion units is arranged in a symmetrical manner,
wherein the power distribution system is configured to, when one electric propulsion unit of the plurality of first electric propulsion units fails, to switch off another electric propulsion unit of the plurality of first electric propulsion units to maintain a symmetry of the plurality of first electric propulsion units and a thrust provided by the plurality of first electric propulsion units.

16. The power distribution system of claim 1, wherein the plurality of first electric propulsion units comprises rotors configured to propel an aircraft in a first direction, and
wherein the second electric propulsion unit comprises a rotor configured to propel the aircraft in a second direction.

17. The power distribution system of claim 1, wherein the plurality of first electric propulsion units comprises lift rotors of an Electric Vertical Take Off and Landing aircraft, and
wherein the second electric propulsion unit is a pusher rotor of the Electric Vertical Take Off and Landing aircraft.

18. The power distribution system of claim 1, wherein each first electric propulsion unit of the plurality of first electric propulsion units comprises a first plurality of electric motors,
wherein each energy supply system configured to power a first electric propulsion unit powers an electric motor of the first plurality of electric motors of the respective electric propulsion unit of the plurality of first electric propulsion units,
wherein the second electric propulsion unit comprises a second plurality of electric motors,
wherein each energy supply system configured to power the second electric propulsion unit powers an electric motor of the second plurality of electric motors of the second electric propulsion unit.

19. A power distribution system comprising:
a plurality of energy supply systems;
a plurality of first electric propulsion units;
a second electric propulsion unit different from the plurality of first electric propulsion units; and
at least one double throw switch,
wherein each energy supply system of the plurality of energy supply systems is configured to power at least two electric propulsion units of the plurality of first electric propulsion units,
wherein each first electric propulsion unit of the plurality of first electric propulsion units is configured to be powered by at least two energy supply systems of the plurality of energy supply systems, and
wherein each double throw switch of the at least one double throw switch is configured to connect the second electric propulsion unit with one or another of two energy supply systems of the plurality of energy supply systems.

20. The power distribution system of claim 19, wherein each energy supply system of the plurality of energy supply systems is configured to power two electric propulsion units of the plurality of first electric propulsion units through a corresponding power bus of a plurality of power buses,
wherein power buses of the plurality of power buses are not interconnected, and
wherein each double throw switch of the at least one double throw switch is configured to connect to one or another of two power buses of the plurality of power buses.
